(19) United States
(12) Patent Application Publication
(10) Pub. No.: US 2019/0162450 A1
(43) Pub. Date: May 30, 2019

(54) Inflatable non-imaging solar concentrator water desalination system

(71) Applicant: Yonghua Wang, Klamath Falls, OR (US)

(72) Inventor: Yonghua Wang, Klamath Falls, OR (US)

(21) Appl. No.: 15/732,558

(22) Filed: Nov. 27, 2017

(51) Int. Cl. F24S 80/52; C02F 1/14; F24S 70/30; C02F 1/26; F24S 80/50; F24S 25/00; C02F 103/08

(52) U.S. Cl. CPC F24S 80/52; C02F 1/14; F24S 70/30; C02F 2103/08; F24S 2080/503; F24S 2025/01; C02F 1/265

(57) ABSTRACT

An inflatable non-imaging solar concentrator water desalination system comprises an inflatable non-imaging stationary solar concentrator and shallow black basin type evaporator. The evaporator is made into a semi-close structure house like a stadium to surround the concentrator. An absorber made of black coating or porous absorption materials is placed on the basin of the concentrator. The evaporator consists of an inner holder, a outer holder, a freshwater collector, and a condenser to form a space for water to evaporate, and to be condensed and collected. The inflatable non-imaging solar concentrator is assembled with the evaporator in such a way that the output aperture of the solar concentrator is directly over the surface of the absorber

### TECHNICAL FIELD

The present disclosure relates generally to water desalination. More specifically, to inflatable non-imaging solar concentrator water desalination system.

### BACKGROUND

Water use and handling technologies are an essential part of world infrastructure, and which is increasingly being stressed due to age, population growth, competing energy demands, and increasing disruption of natural hydrologic cycles leading to regional water scarcity. Desalination is increasingly being considered as an important potential solution to increase water supplies for municipal water and agriculture, and is an essential technology to purify water produced from various industrial processes, as well as from oil and gas exploration. Each market presents different possible avenues to integrate solar thermal energy into the process as the primary energy resource. Most municipal desalination in the U.S. utilizes reverse osmosis (RO), which is performed at ambient temperatures with no special heating of the feed stream. However, low-cost solar thermal energy can potentially make thermal desalination a low cost option, while reducing demand for electricity, the primary energy input into RO processes. Agriculture has high water demands with runoff that is typically saline due to salts in the soil and groundwater occurring naturally high salt content and is often generated away from grid infrastructure. Thermal desalination, in general, has particular application for water with high total dissolved salt (TDS) content or for applications that require zero liquid discharge (ZLD), which RO cannot typically address.

One of the solar desalinations is called solar distillation (John A. Duffie and William A. Beckman, Solar Engineering of Thermal Processes, 4^{th} Edition, PP 640-647). This still utilizes a shallow black basin to hold the salt water and absorb solar radiation; water vaporize from the brine, condense on the underside of a sloped transparent cover, run into troughs, and is collected in tanks at the end of the still. The advantage of the still is that the incident solar radiation is directly absorbed to evaporate the water. The drawback of this still is that the vapor condensed on the transparent cover reduces the transparency of the cover, and consequently, reduces the efficiency of the still. The other drawbacks of the still are that the basin occupies large area of land and the large area bottom of the basin needs to be insulated.

Another solar desalination is concentrating solar distillation. In this still, the concentrating solar thermal technologies are used to convert the solar flux into heat, and then transfer the heat to a heat exchanger to evaporate the water from brine. Although this approach overcomes the drawbacks of the shallow black basin based green-house type still described above, the conventional collecting elements the concentrators are costly and the system is complicated.

The goal of this application is to provide a paradigm of design of concentrating solar thermal desalination system that directly concentrate solar flux and deliver it to the shallow black basin of desalination system, and dramatically reduce the cost of concentrating system by employing my newest innovation “Inflatable Non-imaging Solar Concentrator” (INSC). The INSC with a close structure made of thin and light materials is not only able to extraordinarily reduce the cost of the concentrator itself, but also able to get rid of any support and fasten parts with a gas expanded membrane apparatus. The INSC can concentrate not only beam light, but also diffuse light with high concentration ratio up to more than 100 suns. The INSC is combined with a shallow black basin type of envelope to form a compact desalination system.

The desalination system disclosed in this application is formed by placing the INSC into an envelope with a shallow black basin as the bottom stand and a hollow core close structure house connected to the stand. On the top of the house, a combined condenser and freshwater collector is integrated. When it is being operated, the incident sunlight is concentrated to the absorption coating or block made of porous materials through the INSC sitting on the shallow black basin and evaporates the water; the generated steam from the basin rise in the house of the envelope and arrive at the condenser; then the condensed water is collected by the collector.

### Objects and Advantages

In this disclosure, the INSC, which is super-light, ultra-low cost, and extremely simple, is employed to directly concentrate the incident sunlight to the absorber located at the basin of the evaporator which is attached to the INSC, so that the intermedia processes happen in other concentrating solar thermal systems are completely avoided and the heating efficiency is dramatically raised. Since the INSC is a gas expanded self-supporting structure, there is no needs for other support structure. The envelop evaporator is simply an attachment to INSC. This makes the whole desalination system a compact and portable system. INSC is separated with the evaporator house and merged into the brine water, so the generated vapor of water will not condense on the output aperture of the concentrator and there is no transparency loss on the concentrator. By using INSC, the area of the shallow black basin inside the envelop evaporator is dramatically reduced, that enables a much better insulation and evaporator structure design.

### SUMMARY

In summary, this invention provides an ultra-high efficiency and extremely low-cost solar desalination system. This system is based on the Inflatable Non-imaging Solar Concentrator (INSC), which is extremely cheap in the sense that cheap thin materials and thin coating films are used to form a gas expanded structure without support parts. The concentrator directly concentrate the incident sunlight to the absorber merged in the brine water to evaporate it so that the heating efficiency is dramatically enhanced. An evaporator based on the shallow black basin is attached to the INSC to form the entire desalination system and the sunlight collecting space and the water evaporation space are separated. The shallow black basin area is dramatically shrunken to facilitate the insulation and the evaporation operation.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is the overview of the assembly of the inflatable non-imaging solar concentrator water desalination system. It is a combination of a inflatable non-imaging solar concentrator and a shallow black basin based evaporator as a envelope to the solar concentrator.

FIG. 2 is the cross section of the assembly of the inflatable non-imaging solar concentrator water desalination system. Where, the close structure of the solar concentrator, the structure of the evaporator consist of shallow black basin, the house formed by inner and outer holders, and the combined condenser and collector, are shown.

### DETAILED DESCRIPTION

Reference will now be made in detail to the present exemplary embodiment, example of which is illustrated in the accompanying drawings. Wherever possible, the same reference numbers will be used throughout the drawings to refer to the same or like parts.

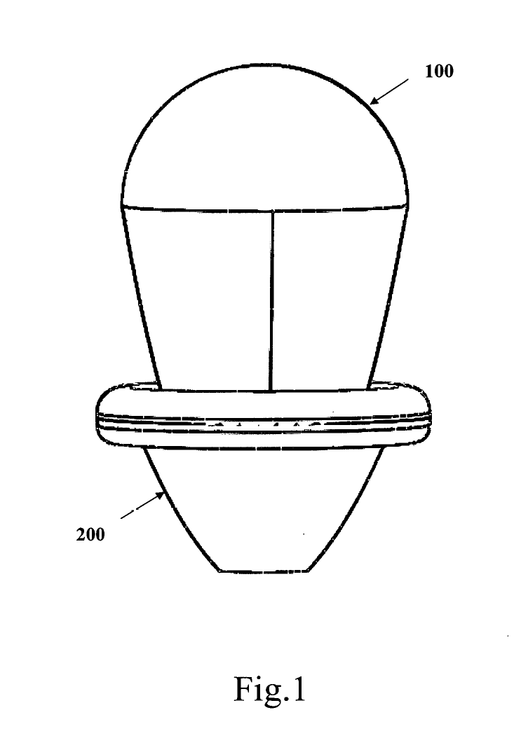

Referring to FIG. 1, the inflatable non-imaging solar concentrator water desalination system comprises two major components inflatable non-imaging solar concentrator 100, which is a close structure stationary solar concentrator and is able to concentrate both beam light and diffuse light, and evaporator 200 as an envelop surrounding the concentrator 100. The bottom of the concentrator 100 is directly sitting on the bottom of the evaporator 200 to concentrate the incident light to the absorber located on the bottom of the evaporator 200. The brine water feeding in the basin of the evaporator 200 is evaporated by the absorber.

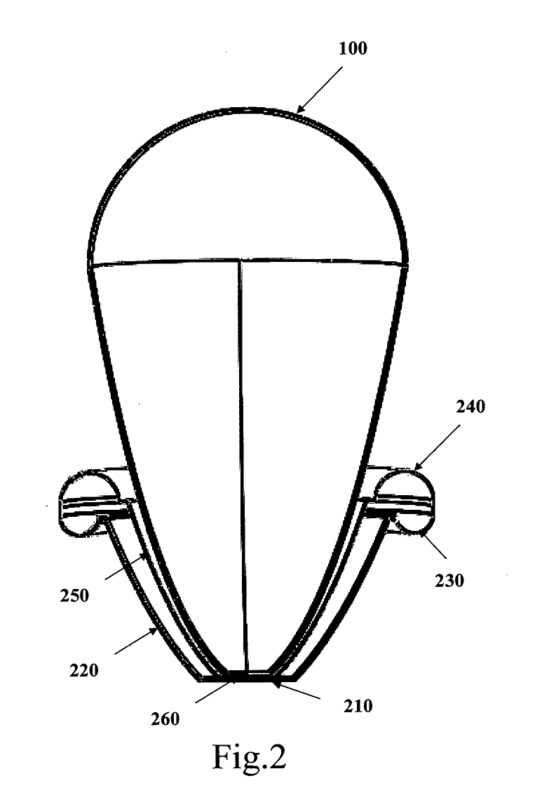

Referring FIG. 2, the evaporator 200 consists of the black basin 210, the outer holder 220, the freshwater collector 230, the condenser 240, the inner holder 250, and the absorber 260. The inner holder and outer holder form a house for evaporation. When in operation, the brine water is feed in the basin 210; the incident sunlight is concentrated to the absorber 260 merged into the brine water to evaporate the water; the vapor generated on the surface of the brine water rise in the house formed by the inner holder 250 and outer holder 220, and arrive at the condenser 240, and get condensed there, then is collected by the collector 230.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. An inflatable non-imaging solar concentrator water desalination system, comprising:
a. an inflatable non-imaging solar concentrator,
b. an shallow black basin type evaporator,
c. a black coating or porous materials block absorber;
wherein, the evaporator is made into a semi-close structure to surround the concentrator as an envelope, and an absorber is located on the basin of the evaporator, the incident sunlight is concentrated to the absorber to evaporate water through the concentrator.

2. The inflatable non-imaging solar concentrator of claim 1 is a stationary concentrator.

3. The evaporator of claim 1 consists a black basin, a outer holder, a freshwater collector, a condenser, and a inner holder to form a semi-close structure house.

4. The black coating or porous materials block absorber of claim 1 is located on the basin of claim 3.

5. The inflatable non-imaging solar concentrator of claim 1 is assembled with the evaporator of claim 1 in such a way that the output aperture of the solar concentrator is directly over the surface of the absorber of the claim 4.
